(19) United States
(12) Patent Application Publication
(10) Pub. No.: US 2016/0309726 A1
(43) Pub. Date: Oct. 27, 2016

(54) Organic Pesticide Compositions

(71) Applicant: Mark Wilson, Denville, NJ (US)

(72) Inventor: Mark Wilson, Denville, NJ (US)

(21) Appl. No.: 14/695,899

(22) Filed: Apr. 24, 2015

(51) Int. Cl. A01N 65/22; A01N 37/02; A01N 65/08

(52) U.S. Cl. CPC A01N 65/22; A01N 65/08; A01N 37/02

(57) ABSTRACT

Concentrated organic pesticide compositions have active ingredients of two plant essential oils, cedar oil and peppermint oil, which synergistically act as arthropod repellants, and 2-phenethyl propionate, which kills arthropods on contact. Inert adjuvant ingredients are ethyl lactate, a surfactant, and sodium lauryl sulfate, an emulsifier, both of which facilitate dispersion of the oils in water. Dilution of the concentrated compositions with water for spray application is preferably at a ratio of about 1:640 by volume. All ingredients comply with USEPA/FIFRA regulations for minimum risk pesticides.

### FIELD OF INVENTION

The present invention relates to the field of pesticide compositions and more particularly to organic pesticide compositions consisting exclusively of ingredients classified as minimum risk pesticides under the Federal Insecticide, Fungicide & Rodenticide Act (FIFRA).

### BACKGROUND OF THE INVENTION

Effective control of insects and other arthropod pests is an important public health imperative. Exposure of humans and domestic animals to ticks, mosquitoes, fleas and other arthropod pests spreads diseases, and anthropod pests can also damage plants and foliage. Environmentally benign pesticides must be safe for use in areas frequented by children, pets and wild life, as well as non-toxic to plant life.

“Minimum risk pesticides” are a special class of pesticides that are not subject to federal registration requirements, because their ingredients, both active and inert, are demonstrably safe. Pursuant to Section 25(b) of FIFRA and the federal regulations issued thereunder, listed active and inactive ingredients are acceptable for use in minimum risk pesticide products. Therefore, an environmentally benign pesticide product should contain only active ingredients which appear on the FIFRA 25(b) active ingredients list and inert ingredients which appear on the FIFRA inert ingredients List 4A.

Synergy of ingredients is another important feature of safe and effective natural pesticide compositions. The combination of ingredients should be significantly more effective and its effectiveness more long-lasting than if each ingredient were used separately. Highly concentrated compositions, with little or no water content, are also preferably due to longer shelf life and lower shipping costs. To facilitate dilution and spraying of the product, an optimal pesticide composition should also contain adjuvant surfactants and/or emulsifiers, which must also be approved minimum risk pesticide ingredients.

### SUMMARY OF THE INVENTION

The organic pesticide compositions of the present invention comprise three active ingredients and at least one inert adjuvant ingredient. The active ingredients include two plant essential oils, cedar oil and peppermint oil, which act primarily as insect repellants. When combined in the proper proportions, these two essential oils produce a synergistic increase both in repellent effect and residual longevity of the applied product. To achieve this synergy, the cedar oil ingredient should be in the approximate range of 30% to 40% by weight of the composition, and the peppermint oil should be in the approximate range of 1% to 5% by weight of the composition. The synergism of these two essential oils in these proportions prolongs the applied products residual effectiveness up to 3 to 4 weeks, depending on rainfall. Both cedar oil and peppermint oil appear on the FIFRA Section 25(b) list of minimum risk pesticide active ingredients.

The third active ingredient of the organic pesticide compositions is 2-phenethyl propionate (also known as 2-phenylethyl propionate), which kills insects on contact by attacking their exoskeletons. This active ingredient is most effective, in combination with the two essential oils, at a concentration in the approximate range of 10% to 15% by weight of the composition. The 2-phenethyl propionate is also on the FIFRA 25(b) list of minimum risk pesticide active ingredients.

The organic pesticide compositions of the present invention are 100% concentrates, with no added water. For maximum effectiveness and residual duration, they are designed to be diluted with water at a ratio in the approximate range of 1:500 to 1:750, such that one gallon of the diluted product treats an area of 1,000 to 2,000 square feet, depending on the level of infestation and density of foliage.

The organic pesticide composition of the present invention contains at least one inert adjuvant ingredient, which acts as a surfactant to disperse the active ingredients, particularly the essential oils, in water when the concentrated product is diluted for use. A second inert adjuvant can also be added, with the second inert ingredient acting as an emulsifier to better disperse the essential oils so that they don't clog the spray applicators. The surfactant adjuvant is ethyl lactate in the approximate range of 40% to 45% by weight of the composition. If an emulsifier adjuvant is added, it is in a ratio of about 1:10 in relation to the surfactant for maximum synergistic effect. The emulsifier, if present, is decaglycerol mono/dioleate (CAS #9007-48-1, sold under the trademark CAPROL® PGE 860) in the approximate range of 4% to 5% by weight of the composition. Ethyl lactate is on the FIFRA 25(b) list of minimum risk pesticide active ingredients, and decaglycerol mono/dioleate is on the FIFRA List 4A of minimum risk pesticide inert ingredients.

The foregoing summarizes the general design features of the present invention. In the following sections, specific embodiments of the present invention will be described in some detail. These specific embodiments are intended to demonstrate the feasibility of implementing the present invention in accordance with the general design features discussed above. Therefore, the detailed descriptions of these embodiments are offered for illustrative and exemplary purposes only, and they are not intended to limit the scope either of the foregoing summary description or of the claims which follow.

### DETAILED DESCRIPTION OF THE PREFERRED EMBODIMENTS

In the first embodiment of the present invention, the organic pesticide composition is primarily designed to control ticks. The ingredients and concentrations by weight are as follows:

Active Ingredients:

| | |
|---|---|
| Cedar Oil | 39.7% |
| 2-Phenethyl Propionate | 14.7% |
| Peppermint Oil | 1.0% |

Inert Ingredients:

| | |
|---|---|
| Ethyl Lactate | 44.6% |
| | 100% |

This concentrate product is diluted with water at ½ ounce to 2.5 gallons of water (1:640) and applied by spray applicator at approximately ½ to 1 gallon of diluted product per 1,000 square feet of area, with the rate of application varied based on the level of infestation and the density of foliage/vegetation. Recommended application is every 30 to 60 days.

The second embodiment is also an organic pesticide composition primarily designed to control ticks. In this formulation, an emulsifier is added to inhibit oil buildup in the spray applicator:

Activie Ingredients:

| | |
|---|---|
| Cedar Oil | 38% |
| 2-Phenethyl Propionate | 14% |
| Peppermint Oil | 1% |

Inert Ingredients:

| | |
|---|---|
| Ethyl Lactate | 42.8% |
| Decaglycerol mono/dioleate | 4.2% |

Dilution ratios and application rate is approximately the same as for the first embodiment.

Although the preferred embodiments of the present invention have been disclosed for illustrative purposes, those skilled in the art will appreciate that many additions, modifications and substitutions are possible, without departing from the scope and spirit of the present invention as defined by the accompanying claims.

What is claimed is:

1. An organic pesticide composition comprising:
a first active ingredient, consisting of a cedar oil, a second active ingredient, consisting of peppermint oil, and a third active ingredient, consisting of a 2-phenethyl propionate;
wherein the first active ingredient constitutes 30% to 40% by weight of the pesticide composition, the second active ingredient constitutes 1% to 5% by weight of the pesticide composition, and the third active ingredient constitutes 10% to 15% by weight of the pesticide composition.

2. The organic pesticide composition of claim 1, further comprising:
a first inert ingredient, consisting of ethyl lactate, wherein the first inert ingredient constitutes 40% to 45% by weight of the pesticide composition.

3. The organic pesticide composition of claim 2, further comprising:
a second inert ingredient, consisting of decaglycerol mono/dioleate, wherein the second inert ingredient constitutes 4% to 5% by weight of the pesticide composition.

4. The organic pesticide composition of claim 1, wherein the pesticide composition is diluted with water at a ratio in a range of 1:500 to 1:750 by volume before being applied.

5. The organic pesticide composition of claim 2, wherein the pesticide composition is diluted with water at a ratio in a range of 1:500 to 1:750 by volume before being applied.

6. The organic pesticide composition of claim 3, wherein the pesticide composition is diluted with water at a ratio in a range of 1:500 to 1:750 by volume before being applied.
